(19) United States
(12) Patent Application Publication
(10) Pub. No.: US 2010/0158163 A1
(43) Pub. Date: Jun. 24, 2010

(54) Velocity Estimation Algorithm for a Wireless System

(76) Inventors: Kuo-Ming Wu, Nan-Tou Hsien (TW); Wen-How Lee, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 12/342,044

(22) Filed: Dec. 22, 2008

(51) Int. Cl. H04L 27/06

(52) U.S. Cl. 375/343

(57) ABSTRACT

A method for estimating the velocity of the Mobile Station (MS) in Orthogonal Frequency Divisional Multiplexing (OFDM)/Orthogonal Frequency Divisional Multiplexing Access (OFDMA) system is disclosed. First, the pilots in the preamble are received by MS and the pilots in a specified symbol of the specific zone are received by MS. An auto-correlation between the received pilots in preamble and the received pilots in the specified symbol of the specific zone is calculated. The auto-correlation is the calculated with frame by frame basis, and the average auto-correlation is calculated from number of frames. Once the average auto-correlation is obtained, the velocity of MS is estimated from predetermined function according to the obtained average auto-correction.

### BACKGROUND OF THE INVENTION

1. Field of the Invention

2. Description of the Prior Art

The wireless communications have to work in a wide range of channels states, such that mobile user velocities are ranged between 0 and 350 km/hr. Orthogonal Frequency Divisional Multiplexing (OFDM)/Orthogonal Frequency Divisional Multiplexing Access (OFDMA) are promising technologies to fulfill the above mentioned requirement. However, a powerful and low-complexity velocity estimation scheme is necessary to not only keep the estimation errors as small as possible but also keep the calculation as simple as possible. Future mobile communication systems have to provide reliable data service at high data rates for different channel states.

### SUMMARY OF THE INVENTION

A method for estimating the velocity of the Mobile Station (MS) in OFDM/OFDMA system is disclosed. First, the pilots in preamble are received by MS and the pilots in a specified symbol of the specific zone are received by MS. An auto-correlation between the received pilots in preamble and the received pilots in the specified symbol of the specific zone is calculated. The auto-correlation is calculated with frame by frame basis, and the average auto-correlation is calculated from number of frames. Once the average auto-correlation is obtained, the velocity of MS is estimated from a predetermined function according to the obtained average auto-correction. The channel condition of the above method is under specific channel, and the predetermined function is depended upon the specific channel. A number of look-up tables (LUTs) for representing the relationship between the average auto-correlation value and the estimated velocity of MS are generated for estimating the approximated velocity of MS or the range of the estimated velocity of MS. The estimated velocity of MS is dependent on the factors of the obtained average auto-correlation, Fast Fourier Transform (FFT) size, sampling frequency, the specified symbol and the representative center frequency. For simplicity method, the specified symbol in the specified zone is selected for each of different bandwidths. By doing so, the effect of sampling frequency and FFT size are eliminated. In addition, the unified LUT is generated by choosing a representative of the center frequency for every band class in order to reduce the number of LUTs which digital signal processing have to handle.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1-2 are graphs of the non-linear property of modified 0^{th} order Bessel function of the first kind.

FIG. 3 shows how by choosing a specific symbol in the zone for different bandwidths causes the autocorrelation value vs. velocity is depended upon the representative center frequency.

FIG. 4 shows one embodiment's method of selecting a representative center frequency for each Band Class.

FIG. 5 illustrates calculating the maximum estimated velocity for each representative center frequency in FIG. 4

FIG. 6 shows a lookup table for estimating velocity according to one exemplary embodiment.

### DETAILED DESCRIPTION

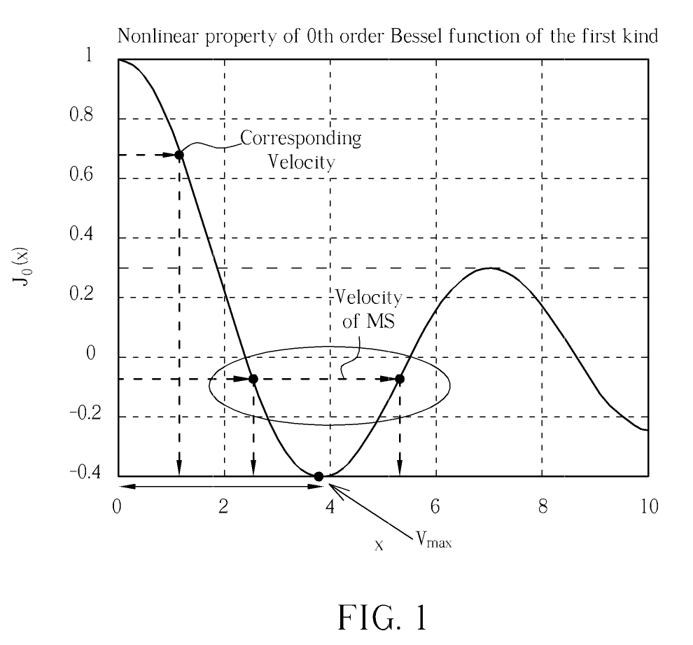

A detailed description of exemplary embodiments of the present invention is provided with respect to Equation 1-6 and FIGS. 1-6. Equation 1 is an autocorrelation function of the Channel Frequency Response (CFR) in a Rayleigh fading channel by locating the CFR at subcarrier K of preamble symbol and CFR at subcarrier K of symbol n at downlink sub-frame. Symbol n is the specified symbol in the specific zone, which is downlink sub-frame in this exemplary embodiment. The function equates to the shown modified 0^{th} order Bessel function of the 1^{st} kind, which uses the maximum Doppler frequency and symbol duration as inputs. This in turn can be converted to estimate the velocity of MS. Equation 1 is able to calculate an autocorrelation between the received pilot in the preamble and pilot in the specified symbol of the specific zone.

$$\begin{matrix}ρ 〈 n 〉 = \frac{E \{ {H}_{preamble , k} \cdot {H}_{zone , n , k}^{*} \}}{\sqrt{E \{ {\vert {H}_{preamble , , k} \vert}^{2} \}} \cdot \sqrt{E \{ {\vert {H}_{zone , n , k} \vert}^{2} \}}} \\ = {J}_{0} ( 2 π {f}_{d , Max} {nT}_{s} ) \\ = {J}_{0} ( \frac{π \cdot {N}_{FFT} \cdot {f}_{c\_GHz} \cdot {v}_{KM\_HR} \cdot n}{480000 \cdot {f}_{s\_MHz}} )\end{matrix} \qquad Equation 1$$

where n≧1
H_{preamble, k}: CFR at subcarrier k of preamble symbol at DL subframe (i.e. symbol 0)
H_{zone,n,k}: CFR at subcarrier k of symbol n at DL subframe.

Please note that the assumptions of the predetermined channel is a Rayleigh fading channel and the specific function is a modified 0^{th} order Bessel function of 1^{st} kind are only for illustration purpose because the Raleigh channel is commonly used in mobile system. However, the present invention is not limited to the certain predetermined channel or the specific function. In other exemplary embodiments, some other channel conditions and corresponding functions may also be applied to the equations through the description with the slight modifications. For example, in the Ricean Channel, other specific functions might be used and the equations through the context are still applied with only the mapping function needing to be changed. In addition, please note that the MS through the context can be referred to any workable device in OFDM/OFDMA systems.

In practice application, an estimated autocorrelation at each frame is illustrated in equation 2. In equation 2, the error variance term χ is introduced and χ is a correction term for the autocorrelation function at a condition with low Signal to Noise Ratio (SNR). In general, the SNR may become quite low in noisy urban environments or when at great distances from the serving cell, and the correction term can be useful in more accurately obtaining the estimated velocity of MS.

$$\begin{matrix}\hat{ρ} 〈 n 〉 = \frac{E \{ {\hat{H}}_{preamble , k} \cdot {\hat{H}}_{zone , n , k}^{*} \}}{\sqrt{E \{ {\vert {H}_{preamble , , k} \vert}^{2} \}} \cdot \sqrt{E \{ {\vert {H}_{zone , n , k} \vert}^{2} \}}} \\ = \frac{E \{ {H}_{preamble , k} \cdot {H}_{zone , n , k}^{*} \}}{\sqrt{E \{ {\vert {H}_{preamble , , k} \vert}^{2} \} + {σ}_{preamble}^{2}} \cdot \sqrt{E \{ {\vert {H}_{zone , n , k} \vert}^{2} \} + {σ}_{zone , n}^{2}}} \\ = ρ ( n ) / χ\end{matrix} \\ where \\ χ = \sqrt{( \begin{matrix}1 + \frac{{σ}_{zone , 2}^{2}}{E \{ {\vert {H}_{zone , n , k} \vert}^{2} \}} + \frac{{σ}_{preamble}^{2}}{E \{ {\vert {H}_{preamble , , k} \vert}^{2} \}} + \\ \frac{{σ}_{zone , n}^{2} \cdot {σ}_{preamble}^{2}}{E \{ {\vert {H}_{zone , n , k} \vert}^{2} \} \cdot E \{ {\vert {H}_{preamble , , k} \vert}^{2} \}}\end{matrix} )} \qquad Equation 2$$

σ²_{preamble}: CFR estimation error variance at preamble symbol
σ²_{zone,n}: CFR estimation error variance at zone symbol n

An equation for such a “one-shot” AFC estimate at frame I is shown in equation 3, which takes the real part of the product between a “Smoothed” preamble subcarrier Channel Estimation (CE) at CE output and the conjugate of a “Raw” pilot subcarrier CE at the Fast Furrier Transformation (FFT) output.

$$\begin{matrix}{\hat{ρ}}^{( i )} ( n ) = \frac{{\sum }_{k} Re \{ {\hat{H}}_{preamble}^{( i )} \cdot {\hat{H}}_{zone , n , k}^{( i ) *} \}}{\sqrt{{\sum }_{k} {\vert {\hat{H}}_{preamble , k}^{( i )} \vert}^{2}} * \sqrt{{\sum }_{k} {\vert {\hat{H}}_{zone , n , k}^{( i )} \vert}^{2}}} \\ = \frac{{\hat{A}}^{( i )} ( n )}{\sqrt{{\hat{B}}^{( i )} ( n )} \cdot \sqrt{{\hat{C}}^{( i )} ( n )}}\end{matrix} \\ where \\ {\hat{A}}^{( i )} ( n ) = {\sum }_{k} Re \{ {\hat{H}}_{preamble}^{( i )} , k \cdot {\hat{H}}_{zone , n , k}^{( i ) *} \} \\ {\hat{B}}^{( i )} ( n ) = {\sum }_{k} {\vert {\hat{H}}_{preamble , k}^{( i )} \vert}^{2} \\ {\hat{C}}^{( i )} ( n ) = {\sum }_{k} {\vert {\hat{H}}_{zone , n , ke}^{( i )} \vert}^{2} \qquad Equation 3$$

Smoothed ACF estimate at frame I is to calculate the average autocorrelation over frames to gain a better estimation result. As can be seen in equation 4, the smoothed AFC estimate at frame I, which includes an SNR correction term, can be obtained assuming a preamble CE error is small, which is the case of interest in this disclosure.

$${\overline{A}}^{( i )} ( n ) = α {\hat{A}}^{( i )} + ( 1 - α ) {\overline{A}}^{( i - 1 )} ( n )$$

$${\overline{B}}^{( i )} ( n ) = α {\hat{B}}^{( i )} + ( 1 - α ) {\overline{B}}^{( i - 1 )} ( n )$$

$${\overline{\hat{C}}}^{( i )} ( n ) = α {\hat{C}}^{( i )} + ( 1 - α ) {\overline{C}}^{( i - 1 )} ( n )$$

$$\begin{matrix}{\overline{ρ}}^{( i )} ( n ) = \frac{{\overline{A}}^{( i )} ( n )}{\sqrt{{\overline{B}}^{( i )} ( n ) \cdot {\overline{C}}^{( i )} ( n )}} \cdot χ \\ = \frac{{\overline{A}}^{( i )} ( n )}{\sqrt{{\overline{B}}^{( i )} ( n ) \cdot {\overline{C}}^{( i )} ( n )}} \cdot \sqrt{1 + \frac{1}{S N {R}_{zone , n}^{( i )}}} \\ \approx = \frac{{\overline{A}}^{( i )} ( n )}{\sqrt{{\overline{B}}^{( i )} ( n ) \cdot {\overline{C}}^{( i )} ( n )}} \cdot ( 1 + \frac{0.5}{S N {R}_{zone , n}^{( i )}} )\end{matrix}$$

$$S N {R}_{zone , n}^{( i )} \approx \frac{CINR {3}_{preamble}^{( i )}}{8.0} \cdot \frac{16.0}{9.0} \cdot {zoneBoostValue}_{n}$$

A correction term χ is

$$\sqrt{1 + \frac{1}{S N {R}_{zone , n}^{( i )}}}$$

since the preamble CE error is assumed to be small in the exemplary example.

In review, the average autocorrelation value over frames between the received pilots in the preamble and the received pilots in the specified symbol is obtained through equation 4.

$${\overline{ρ}}^{( i )} ( n ) = \frac{{\overline{A}}^{( i )} ( n )}{\sqrt{{\overline{B}}^{( i )} ( n ) \cdot {\overline{C}}^{( i )} ( n )}} χ \qquad Equation 4$$

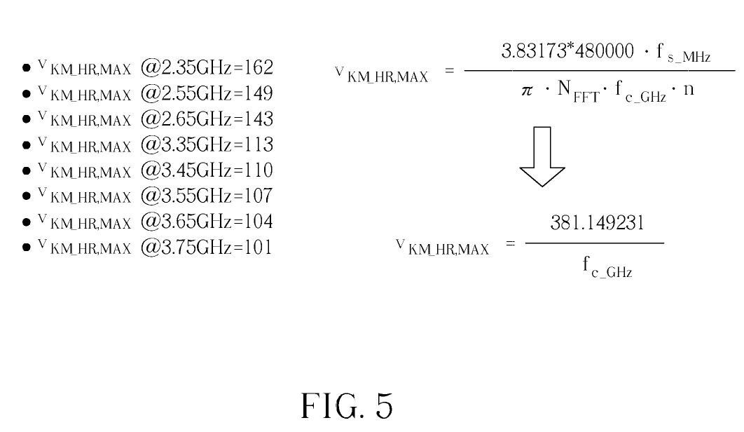

FIG. 5 illustrates the autocorrelation function in this exemplary embodiment of the present invention under the assumption of the predetermined channel is the Rayleigh fading channel and the specific function is the modified 0^{th} order Bessel of 1^{st} kind. The variable x of the modified 0^{th} order Bessel of 1^{st} kind may comprise “velocity”, “FFT size”, “sampling frequency”, “the specified symbol”, and the “representative center frequency”. The corresponding velocity can be estimated through the inverse of J₀ according to the calculated average auto-correlation value.

$${J}_{0} ( x ) = {J}_{0} ( \frac{π \cdot {N}_{F F T} \cdot {f}_{c\_GHz} \cdot {v}_{KM\_HR} \cdot n}{480000 \cdot {f}_{s\_MHz}} ) \qquad Equation 5$$

Please refer to FIG. 1 that is a graph of the Non-linear property of the modified 0^{th} order Bessel of 1^{st} kind. The curve represents the relationship between x values (horizontal axis) and autocorrelation values (vertical axis). The corresponding velocity can be estimated from the inverse of J₀. As can be seen in FIG. 1, ambiguity occurs for velocities in the lower portion of the graph, with an example two indicated possible MS estimated velocities corresponding to the same J₀(x) value. To obtain a better estimated MS velocity, the ambiguity can be resolved by only allowing speeds of the MS in the range between 0 and Vₘₐₓ, which corresponds to the first local minimum of the curve. Vₘₐₓ can be computed from the corresponding x of the first local minimum of the modified 0^{th} order Bessel of 1^{st} kind by equation 6.

$${V}_{KM\_HR , MAX} = \frac{3.83173 \cdot 480000 \cdot {f}_{S\_MHz}}{π \cdot {N}_{F F T} \cdot {f}_{C\_GHz} \cdot n} \qquad Equation 6$$

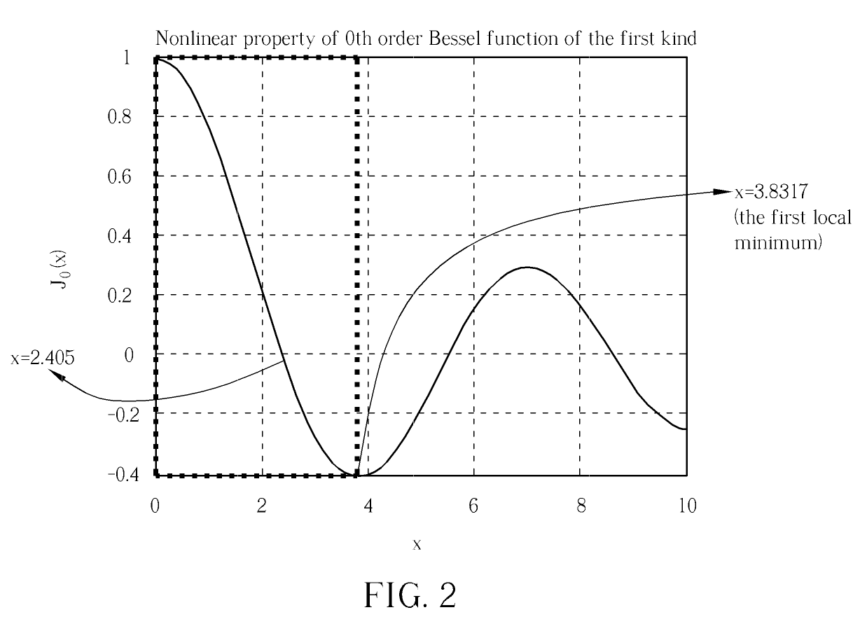

The results of computing Vₘₐₓ are illustrated in FIG. 2, which when compared with FIG. 1 resolves the MS velocity estimation ambiguity as only a single corresponding velocity occurs between 0 and the first local minimum at x=3.8317. This value of x=3.8317, corresponding to the calculated first local minimum, is then used in equation 6 to obtain the maximum estimated MS velocity.

From the Equations 1 and 6, it is known that the maximum estimated velocity Vₘₐₓ and the estimated velocity of MS are depended upon the factors of n, fₛ_{_{—}}_{MHz}, N_{FFT}, and f_{c}_{_{—}}_{GHz}, where n is a specified symbol in the zone, fₛ_{_{—}}_{MHz} is the sampling frequency, N_{FFT} is the FFT size, and f_{c}_{_{—}}_{GHz}, is the representative center frequency. Therefore, a number of look-up tables would be required to account for all possible combinations of these values. In the prefer embodiment, if n is specifically selected for different Bandwidths (BW), the effects of the variables n, fₛ_{_{—}}_{MHz}, and N_{FFT} can be substantially avoided through replacement by a constant. Therefore, a number lookup table of autocorrelation values vs. estimated MS velocity Vₖₘ_{_{—}}ₕᵣ can be constructed to depend only upon the representative center frequency f_{c}_{_{—}}_{GHz}.

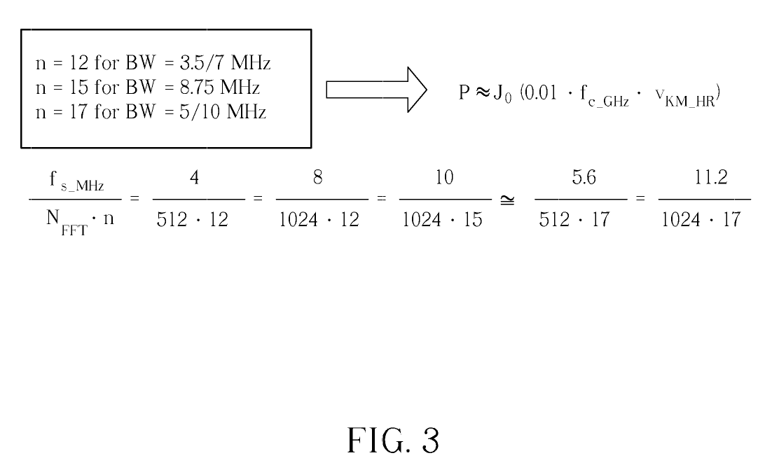

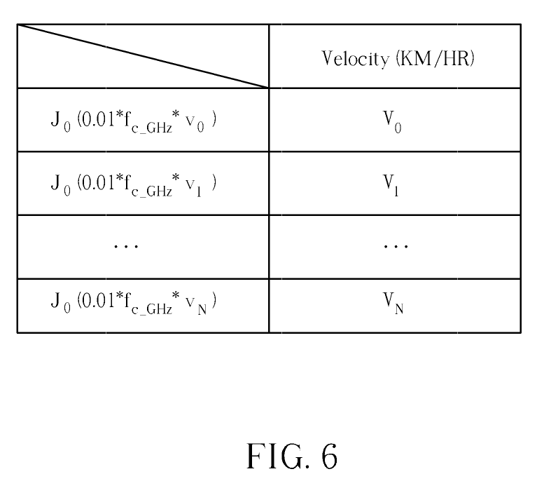

Please refer to FIG. 3 which shows selection of n=12 for BWs of 3.5 and 7 MHz, n=15 for BWs of 8.75 MHz, and n=17 for BWs of 5 and 10 MHz. The values of n used here were determined suitable through experimentation, but other embodiments may use different values for n according to design considerations. When the resulting approximation for n, fₛ_{_{—}}_{MHz}, and N_{FFT} are substituted back into the equations shown in FIG. 1 and simplified, the autocorrelation function now corresponds approximately to the modified Bessel function of the first kind shown in FIG. 3, and the estimated MS velocity varies with the representative center frequency f_{c}_{_{—}}_{GHz}. In addition, the estimated MS velocity can be founded through the look-up table as shown in FIG. 6.

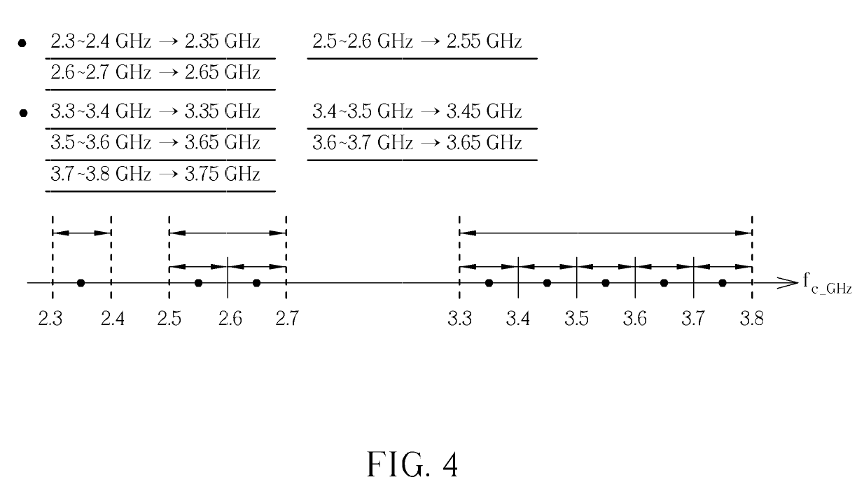

In general, there are still a great number of center frequencies of MS in all of the Band Classes. To further simplify things of the present disclosure, a representative center frequency for each Band Class may be chosen to greatly reduce the number of entries in the lookup table. Taking the WiMAX Forum Mobile System Profile as example, the representative center frequencies may be selected for each Band Class illustrated in FIG. 4.

Thus, for a given representative center frequency, a simple, unified lookup table for each representative center frequency of the present invention can be constructed for each Band Width by varying n (n=12 for BWs of 3.5 and 7 MHz, n=15 for BWs of 8.75 MHz, and n=17 for BWs of 5 and 10 MHz) and the maximum estimated velocities for the different chosen representative center frequencies as is shown in FIG. 5.

Once the maximum estimated velocities for the different representative center frequencies are found via the unified lookup table, MS velocity estimation ambiguities such as shown in FIG. 1 are avoided and final MS velocity estimation simplifies to a look-up table having the relationships depicted in FIG. 6, that of the MS velocity estimation corresponding directly to a modified 0^{th} order Bessel function of the 1^{st} kind whose x value comprises the received representative center frequency f_{c}_{_{—}}_{GHz}, the MS velocity estimation Vₖₘ_{_{—}}ₕᵣ, and a constant term of the sampling frequency, the FFT size, and the specified zone symbol. The look-up table is for looking up autocorrelation and the MS estimated velocity as shown in FIG. 6.

It is an advantage of the present disclosure of utilizing the auto-correlation value between the received pilots in the preamble and the specified symbol in a specific zone to find the corresponding velocity from the predetermined function and constructing the look-up table for obtaining the estimated MS velocity through implementing inverse J₀(x).

Those skilled in the art will readily observe that numerous modifications and alterations of the device and method may be made while retaining the teachings of the invention.

What is claimed is:

1. A method of velocity estimation in a wireless system, comprising:
receiving a plurality of pilots in a preamble;
receiving a plurality of pilots in a specified symbol of a specific zone;
computing an average auto-correlation value between the received pilots in the preamble and pilots in the specified symbol of the specific zone, wherein the average auto-correlation is computed from a number of frames and an auto-correlation between each of the received pilots in the preamble and each of the received pilots in the specified symbol of the specific zone for each frame;
constructing a look-up table having a correlation between a velocity and a general auto-correlation value according to a predetermined channel; and
estimating the velocity by the look-up table according to the computed average auto-correlation.

2. The method of claim 1, wherein the estimated velocity is constrained in-between 0 to a maximum value of an estimated value.

3. The method of claim 2, wherein the maximum value of the estimated value is obtained according to the local minimum of a specific function.

4. The method of claim 3, wherein the specific function is a modified 0^{th} order Bessel functions of a 1^{st} kind and the predetermined channel is a Rayleigh fading channel.

5. The method of claim 1, wherein the average auto-correlation comprises factors of the estimated velocity, a size of Fast Fourier Transform, a sampling frequency, a specified symbol and a representative center frequency.

6. The method of claim 5, wherein the specified symbol in the specific zone is chosen for different bandwidths for the look-up table and estimating the velocity is according to the representative center frequency.

7. The method claim 5, wherein the look-up table is changed with the representative center frequency.

8. The method of claim 6, wherein the look-up table is unified if the representative center frequency is fixed.

9. The method of claim 1, further comprising a correction term for computing an average auto-correlation value thereby a noise and interference effect is reduced.

10. The method of claim 9, the correction term is
$$\sqrt{1 + \frac{1}{S N {R}_{zone , n}^{( i )}}}$$
while a preamble channel estimation error is small.
